(19) United States
(12) Patent Application Publication
(10) Pub. No.: US 2006/0225803 A1
(43) Pub. Date: Oct. 12, 2006

(54) Dual wall co-extruded corrugated tubing

(76) Inventors: Kenneth R. Chenoweth, Ravenna, OH (US); Wayne T. Heverly, Floyds Knobs, IN (US); Russell A. Murray, Sherrard, IL (US)

Correspondence Address: HAHN LOESER & PARKS, LLP, One GOJO Plaza, Suite 300, AKRON, OH, 44311-1076, US

(21) Appl. No.: 11/386,887

(22) Filed: Mar. 22, 2006

Related U.S. Application Data
(63) Continuation of application No. 10/875,919, filed on Jun. 23, 2004, now abandoned.
Application No. 10/875,919 is a continuation of application No. 09/415,743, filed on Oct. 12, 1999, now abandoned.

(51) Int. Cl. F16L 11/00

(52) U.S. Cl. 138/121; 138/122; 138/137; 138/140; 138/141

(57) ABSTRACT

Dual wall co-extruded corrugated tubing which includes an outer corrugated protective layer fabricated from a relatively rigid plastic material, such as polypropylene or nylon, which provides crush strength, abrasion resistance, enhanced burst strength and enhanced thermal resistance and an inner corrugated sealing layer fabricated from a softer, more ductile, polymeric material, such as a thermoplastic elastomer, to provide a sealing surface. The dual wall co-extruded corrugated tubing is preferably fabricated as an integral one-piece component in a single operation and replaces prior art single layer extruded corrugated tubing, which is fabricated from a relatively rigid plastic material, and having end seals, which are fabricated from a softer, more ductile, polymeric material, attached to ends of the length of extruded corrugated tubing in a separate operation.

This application is a continuation of co-pending application Ser. No. 10/875,919, filed Jun. 23, 2004, which is a continuation of co-pending application Ser. No. 09/415,743 filed on Oct. 12, 1999, the disclosure of which is hereby incorporated herein by reference.

### BACKGROUND AND SUMMARY OF THE INVENTION

The present invention relates generally to improvements in dual wall co-extruded corrugated tubing. More particularly, the present invention relates to dual wall co-extruded corrugated tubing which includes an outer corrugated protective layer that provides crush strength, abrasion resistance, enhanced burst strength and enhanced thermal resistance and an inner corrugated sealing layer that provides a sealing surface for the dual wall co-extruded corrugated tubing.

Extruded corrugated tubing is widely used in applications where flexibility of the tubing is desirable, such as in various major household appliances, such as dishwashers and washing machines, as well as in automotive, plumbing and other applications. Prior art extruded corrugated tubing is often fabricated from a relatively rigid plastic material, such as polypropylene or nylon, if crush strength, abrasion resistance, enhanced burst strength and enhanced thermal resistance is desired. However, such prior art extruded corrugated tubing fabricated from a relatively rigid plastic material, such as polypropylene or nylon, is difficult to seal onto other components due to the relatively rigid nature of the plastic materials used.

On the other hand, prior art extruded corrugated tubing is sometimes fabricated from a softer, more ductile material, such as a thermoplastic elastomer (TPE), if sealing the extruded corrugated tubing onto other components is desirable. However, such prior art extruded corrugated tubing fabricated from a softer, more ductile, polymeric material, such as a thermoplastic elastomer, does not provide the crush strength, abrasion resistance, enhanced burst strength and enhanced thermal resistance provided by prior art extruded corrugated tubing fabricated from more rigid plastic materials, such as polypropylene or nylon.

If, in prior art extruded corrugated tubing, it is desired to provide both crush strength, abrasion resistance, enhanced burst strength and enhanced thermal resistance, as well as the ability to seal the extruded corrugated tubing onto other components, an extruded corrugated tubing assembly is sometimes used, which is fabricated from a length of extruded corrugated tubing fabricated from a relatively rigid plastic material, such as polypropylene or nylon, and one or more end seals fabricated from a softer, more ductile, polymeric material, such as a thermoplastic elastomer. While such extruded corrugated tubing assemblies do provide enhanced crush strength, abrasion resistance, enhanced burst strength and enhanced thermal resistance, as well as the ability to seal the extruded corrugated tubing assembly onto other components, joining the end seals to the length of extruded corrugated tubing is generally a separate, additional operation, and thus the cost of fabricating such extruded corrugated tubing assemblies is often more expensive than desirable. In addition, achieving a good joint between the end seals and the length of extruded corrugated tubing is sometimes difficult to consistently achieve.

One prior art multi-layer extruded corrugated tubing arrangement is seen in U.S. Pat. No. 5,792,532 to Pfleger, for “Polymer Tubing.” This United States patent discloses a polymer tubing which may include an inner layer which is inert in respect to the medium being conducted, an intermediate layer which is resistant to pressure and mechanical effects and a very soft polymer outer layer on the surface of the polymer tubing for noise damping. Other prior art multi-layer extruded corrugated tubing arrangements are disclosed in U.S. Pat. No. 4,790,975 to Jarvenkyla, et al., for a “Method and Device for Extrusion of a Double Wall Plastics Pipe”; U.S. Pat. No. 5,305,799 to Dal Palu for a “Flexible Conduit for Vehicle Engine Coolant Circuits” and U.S. Pat. No. 5,706,864 to Pfleger, for “Coolant Conduits.”

However, to applicant's knowledge, none of these prior art extruded corrugated tubing arrangements include an outer corrugated protective layer which provides crush strength, abrasion resistance, enhanced burst strength and enhanced thermal resistance and an inner corrugated sealing layer which provides a sealing surface for the dual wall co-extruded corrugated tubing.

Accordingly, an object of the present invention is the provision of dual wall co-extruded corrugated tubing which includes an outer corrugated protective layer which provides crush strength, abrasion resistance, enhanced burst strength and enhanced thermal resistance and an inner corrugated sealing layer which provides a sealing surface for the dual wall co-extruded corrugated tubing.

Another object of the present invention is the provision of dual wall co-extruded corrugated tubing which is cost effective to fabricate.

Yet another object of the present invention is the provision of dual wall co-extruded corrugated tubing which is fabricated as an integral one-piece component in a single operation.

Still another object of the present invention is the provision of dual wall co-extruded corrugated tubing which is particularly suitable for use in heavy household appliances, such as dishwashers and washing machines.

These and other objects of the present invention are attained by dual wall co-extruded corrugated tubing which includes an outer corrugated protective layer fabricated from a relatively rigid plastic material, such as polypropylene or nylon, which provides crush strength, abrasion resistance, enhanced burst strength and enhanced thermal resistance for the dual wall co-extruded corrugated tubing and an inner corrugated layer fabricated from a softer, more ductile, polymeric material, such as a thermoplastic elastomer, to provide a sealing surface for the dual wall co-extruded corrugated tubing. The dual wall co-extruded corrugated tubing is preferably fabricated as an integral one-piece component in a single operation and replaces prior art single layer extruded corrugated tubing fabricated from, for example, polypropylene, nylon or a thermoplastic elastomer material, as well as extruded corrugated tubing assemblies which are fabricated from a length of extruded corrugated tubing fabricated from a relatively rigid plastic material, such as polypropylene or nylon, and one or more end seals which are fabricated from a softer, more ductile, polymeric material, such as a thermoplastic elastomer, and which are attached to one or both ends of the length of extruded corrugated tubing in a separate operation.

Other advantages and novel features of the present invention will become apparent in the following detailed description of the invention when considered in conjunction with the accompanying drawings.

### BRIEF DESCRIPTION OF THE DRAWINGS

FIG. 1 is a side view of a portion of a prior art extruded corrugated tubing assembly.

FIG. 2 is a side elevational view shown partly in cross-section, of dual wall co-extruded corrugated tubing in accordance with a first preferred embodiment of the present invention.

FIG. 3 is an enlarged cross-sectional view of the dual wall co-extruded corrugated tubing shown in FIG. 2, taken from circle 3-3 in FIG. 2.

FIG. 4 is a side elevational view, shown partly in cross-section, of dual wall co-extruded corrugated tubing in accordance with a second preferred embodiment of the present invention.

FIG. 5 is an enlarged cross-sectional view of the dual wall co-extruded corrugated tubing shown in FIG. 4, taken from circle 5-5 in FIG. 4.

FIG. 6 is a second enlarged cross-sectional view of the dual wall co-extruded corrugated tubing shown in FIG. 4, taken from circle 6-6 in FIG. 4.

FIG. 7 is a side elevational view, shown partly in cross-section, of dual wall co-extruded corrugated tubing in accordance with a third preferred embodiment of the present invention.

FIG. 8 is an enlarged cross-sectional view of the dual wall co-extruded corrugated tubing shown in FIG. 7, taken from circle 8-8 in FIG. 7.

### DETAILED DESCRIPTION

Referring first to FIG. 1, which shows a side view of a prior art extruded corrugated tubing assembly 10, which includes a length of extruded corrugated tubing fabricated from a relatively rigid plastic material, such as polypropylene or nylon, and end seals 14 (only one is shown) fabricated from a softer, more ductile, polymeric material, such as a thermoplastic elastomer. End seals 14 are typically attached to the length of extruded corrugated tubing 12 in a separate operation.

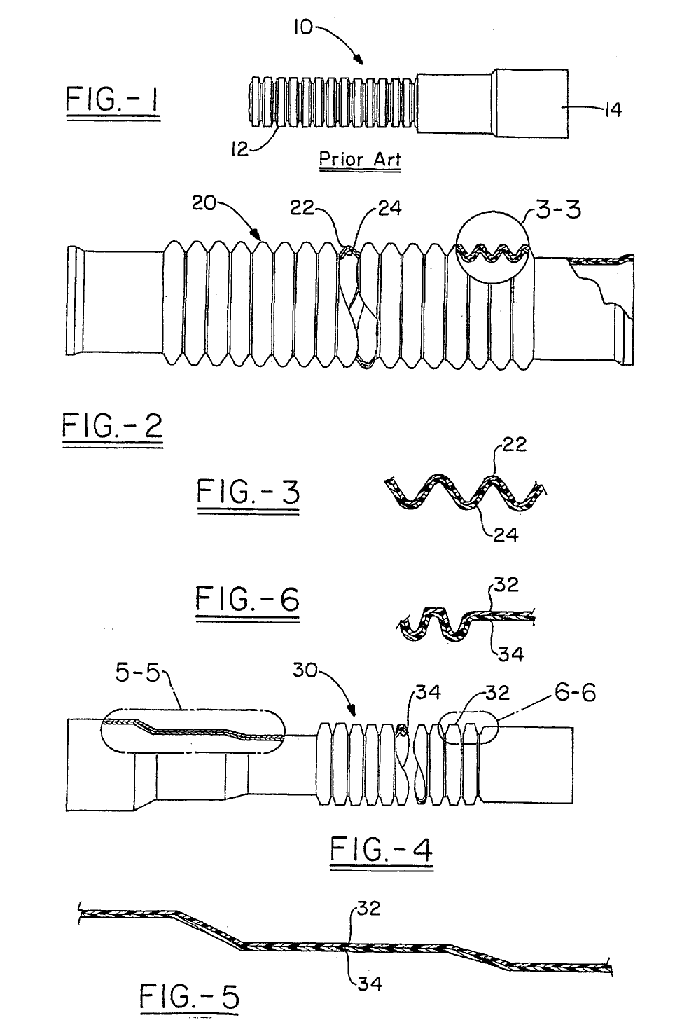

FIGS. 2 and 3, show a dual wall co-extruded corrugated tubing 20 in accordance to an embodiment of the present invention. The dual wall co-extruded corrugated tubing 20 comprises an outer protective layer 22, fabricated into a corrugated configuration in an extrusion process from a relatively rigid plastic material, such as polypropylene or nylon, and a co-extruded corrugated inner sealing layer 24, fabricated from an elastomeric material, such as a thermoplastic elastomer (TPE). Outer corrugated protective layer 22 provides crush strength, abrasion resistance, enhanced burst strength and enhanced thermal resistance for dual wall co-extruded corrugated tubing 20 and inner corrugated sealing layer 24 provides a sealing surface for dual wall co-extruded corrugated tubing 20.

The tubing 20 provides significant advantages in this configuration. By co-extruding both outer layer 22 and inner layer 24, the tubing 20 is formed to provide a sealing surface for a fluid port in the same operation as providing tubing 20 with required crush and abrasion resistance and burst strength in association with outer, more rigid layer 22. This eliminates the separate end seals 14 in the prior art tube of FIG. 1. The tubing 20 is thereby cost-effectively manufactured in a single operation, while providing the desired attributes in an integral configuration. The tubing 20 also increases the speed by which a tubing having an elastomeric material for sealing can be manufactured, as compared to the manufacture of a single layer TPE tubing for example. Dual wall co-extruded corrugated tubing 20 is preferably fabricated as an integral one-piece component in a single operation and replaces prior art single layer extruded corrugated tubing fabricated from, for example, polypropylene, nylon or a thermoplastic elastomer material, as well as extruded corrugated tubing assemblies which are fabricated from a length of extruded corrugated tubing fabricated from a relatively rigid plastic material, such as polypropylene or nylon, and one or more end seals which are fabricated from a softer, more ductile, polymeric material, such as a thermoplastic elastomer, and the one or more end seals are attached to one or both ends of the length of extruded corrugated tubing in a separate operation. Dual wall co-extruded corrugated tubing 20 in accordance with the present invention is anticipated to be used in major household appliances, such as dishwashers and washing machines, as well as in automotive, plumbing and other applications.

Dual wall co-extruded tubing 20 provides both the first and second layers 22 and 24 in a corrugated relationship, with both layers being corrugated and adhered to one another.

The inside diameter of dual wall co-extruded corrugated tubing 20 is preferably in the range of ¼ of an inch to 4 inches and more preferably is in the range of ⅜ of an inch to 1½ inches. In the preferred embodiment of dual wall co-extruded corrugated tubing 20 shown in FIGS. 2 and 3, outer corrugated protective layer 22 is preferably fabricated from a relatively rigid plastic material, such as polypropylene or nylon, and preferably has a thickness in the range of 0.01 of an inch to 0.04 of an inch in the corrugations. Outer corrugated protective layer 22 provides crush strength, abrasion resistance, enhanced burst strength and enhanced thermal resistance for dual wall co-extruded corrugated tubing 20. Inner corrugated sealing layer 24 is preferably fabricated from a softer, more ductile, polymeric material, such as a thermoplastic elastomer, and preferably has a thickness in the range of 0.01 of an inch to 0.04 of an inch in the corrugations. One suitable thermoplastic elastomer material for inner corrugated sealing layer 24 of dual wall co-extruded corrugated tubing 20 is a thermoplastic elastomer material distributed under the trademark SANTOPRENE® by Advanced Elastomer Products. Inner corrugated sealing layer 24 provides a sealing surface for attachment of dual wall co-extruded corrugated tubing 20 to other components.

To form dual wall co-extruded corrugated tubing 20, outer corrugated protective layer 22 and inner corrugated sealing layer 24 are preferably co-extruded in a single operation to form dual wall co-extruded corrugated tubing 20 as an integral one-piece component. The ability to co-extrude the layers 22 and 24 into the corrugated tubing 20 provides an integral wall, with layers 22 and 24 being adhered to one another by chemical reaction at the interface during extrusion.

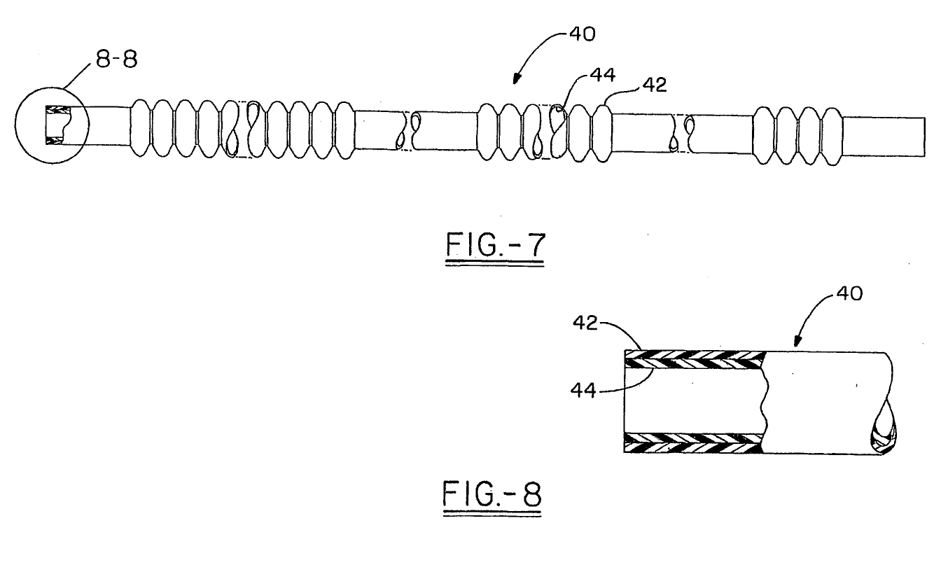

Referring now to FIGS. 4 through 6, dual wall co-extruded corrugated tubing 30, preferably includes outer corrugated protective layer 32, which is preferably fabricated from a relatively rigid plastic material, such as polypropylene or nylon, and inner corrugated sealing layer 34, which is preferably fabricated from a softer, more ductile, polymeric material, such as a thermoplastic elastomer. Outer corrugated protective layer 32 provides crush strength, abrasion resistance, enhanced burst strength and enhanced thermal resistance for dual wall co-extruded corrugated tubing 30 and inner corrugated sealing layer 34 provides a sealing surface for dual wall co-extruded corrugated tubing 30.

Dual wall co-extruded corrugated tubing 30 is preferably fabricated as an integral one-piece component in a single operation and replaces prior art single layer extruded corrugated tubing fabricated from, for example, polypropylene, nylon or a thermoplastic elastomer material, as well as extruded corrugated tubing assemblies which are fabricated from a length of extruded corrugated tubing fabricated from a relatively rigid plastic material, such as polypropylene or nylon, and one or more end seals which are fabricated from a softer, more ductile, polymeric material, such as a thermoplastic elastomer, and the one or more end seals are attached to one or both ends of the length of extruded corrugated tubing in a separate operation. Dual wall co-extruded corrugated tubing 30 in accordance with the present invention is anticipated to be used in major household appliances, such as dishwashers and washing machines, as well as in automotive, plumbing and other applications.

The inside diameter of dual wall co-extruded corrugated tubing 30 is preferably in the range of ¼ of an inch to 4 inches and more preferably is in the range of ⅜ of an inch to 1½ inches. In the preferred embodiment of dual wall co-extruded corrugated tubing 30 shown in FIGS. 4 through 6, outer corrugated protective layer 32 is preferably fabricated from a relatively rigid plastic material, such as polypropylene or nylon, and preferably has a thickness in the range of 0.01 of an inch to 0.04 of an inch in the corrugations. Outer corrugated protective layer 32 provides crush strength, abrasion resistance, enhanced burst strength and enhanced thermal resistance for dual wall co-extruded corrugated tubing 30. Inner corrugated sealing layer 34 is preferably fabricated from a softer, more ductile, polymeric material, such as a thermoplastic elastomer, and preferably has a thickness in the range of 0.01 of an inch to 0.04 of an inch in the corrugations. One suitable thermoplastic elastomer material for inner corrugated sealing layer 34 of dual wall co-extruded corrugated tubing 30 is a thermoplastic elastomer material distributed under the trademark SANTOPRENE® by Advanced Elastomer Products. Inner corrugated sealing layer 34 provides a sealing surface for attachment of dual wall co-extruded corrugated tubing 30 to other components.

To form dual wall co-extruded corrugated tubing 30, outer corrugated protective layer 32 and inner corrugated sealing layer 34 are preferably co-extruded in a single operation to form dual wall co-extruded corrugated tubing 30 as an integral one-piece component.

Referring now to FIGS. 7 and 8, dual wall co-extruded corrugated tubing 40, preferably includes outer corrugated protective layer 42, which is preferably fabricated from a relatively rigid plastic material, such as polypropylene or nylon, and inner corrugated sealing layer 44, which is preferably fabricated from a softer, more ductile, polymeric material, such as a thermoplastic elastomer. Outer corrugated protective layer 42 provides crush strength, abrasion resistance, enhanced burst strength and enhanced thermal resistance for dual wall co-extruded corrugated tubing 40 and inner corrugated sealing layer 44 provides a sealing surface for dual wall co-extruded corrugated tubing 40.

Dual wall co-extruded corrugated tubing 40 is preferably fabricated as an integral one-piece component in a single operation and replaces prior art single layer extruded corrugated tubing fabricated from, for example, polypropylene, nylon or a thermoplastic elastomer material, as well as extruded corrugated tubing assemblies which are fabricated from a length of extruded corrugated tubing fabricated from a relatively rigid plastic material, such as polypropylene or nylon, and one or more end seals which are fabricated from a softer, more ductile, polymeric material, such as a thermoplastic elastomer, and the one or more end seals are attached to one or both ends of the length of extruded corrugated tubing in a separate operation. Dual wall co-extruded corrugated tubing 40 in accordance with the present invention is anticipated to be used in major household appliances, such as dishwashers and washing machines, as well as in automotive, plumbing and other applications.

The inside diameter of dual wall co-extruded corrugated tubing 40 is preferably in the range of ¼ of an inch to 4 inches and more preferably is in the range of ⅜ of an inch to 1½ inches. In the preferred embodiment of dual wall co-extruded corrugated tubing 40 shown in FIGS. 7 and 8, outer corrugated protective layer 42 is preferably fabricated from a relatively rigid plastic material, such as polypropylene or nylon, and preferably has a thickness in the range of 0.01 of an inch to 0.04 of an inch in the corrugations. Outer corrugated protective layer 42 provides crush strength, abrasion resistance, enhanced burst strength and enhanced thermal resistance for dual wall co-extruded corrugated tubing 40. Inner corrugated sealing layer 44 is preferably fabricated from a softer, more ductile, polymeric material, such as a thermoplastic elastomer, and preferably has a thickness in the range of 0.01 of an inch to 0.04 of an inch in the corrugations. One suitable thermoplastic elastomer material for inner corrugated sealing layer 44 of dual wall co-extruded corrugated tubing 40 is a thermoplastic elastomer material distributed under the trademark SANTOPRENE® by Advanced Elastomer Products. Inner corrugated sealing layer 44 provides a sealing surface for attachment of dual wall co-extruded corrugated tubing 40 to other components.

To form dual wall co-extruded corrugated tubing 40, outer corrugated protective layer 42 and inner corrugated sealing layer 44 are preferably co-extruded in a single operation to form dual wall co-extruded corrugated tubing 40 as an integral one-piece component.

Accordingly, although the present invention has been described above in detail, the same is by way of illustration and example only and is not to be taken as a limitation on the present invention. It is apparent to those having a level of ordinary skill in the relevant art that other variations and modifications in dual wall co-extruded corrugated tubing in accordance with the present invention, as described and shown herein, could be readily made using the teachings of the present invention. Accordingly, the scope and content of the present invention are to be defined only by the terms of the appended claims.

What is claimed is:

1. A household appliance composite co-extruded corrugated tubing assembly comprising:
an outer corrugated protective layer having inner and outer corrugated surfaces; and
an inner corrugated layer of a soft thermoplastic elastomer alloy material having inner and outer corrugated surfaces, the inner layer outer corrugated surface being in contact with the protective layer inner corrugated surface over substantially the entire length of each layer through a co-extrusion process, the inner corrugated layer including a means for sealing the tubing assembly to household appliances.

2. The composite co-extruded tubing assembly according to claim 1, wherein corrugations of the inner layer outer corrugated surface are in nesting engagement with corrugations of the protective layer inner corrugated surface.

3. The composite co-extruded tubing assembly according to claim 1, wherein the means for sealing further comprises:
at least one non-corrugated end seal, the end seal comprising an outer protective layer having inner and outer non-corrugated surfaces; and an inner layer having inner and outer non-corrugated surfaces, the inner layer of a soft thermoplastic elastomer alloy material comprising a means for sealing the tubing assembly to household appliances,
the end seal protective layer inner non-corrugated surface being in contact with the end seal protective layer outer non-corrugated surface, each end seal layer being monolithic with a corresponding corrugated layer through a co-extrusion process.

4. The composite co-extruded tubing assembly according to claim 1, wherein the outer protective layer is a polypropylene material.

5. The composite co-extruded tubing assembly according to claim 1, wherein the inner layer has an inside diameter in the range of one-quarter of an inch to four inches.

6. The composite co-extruded tubing assembly according to claim 6, wherein the outer protective layer has a thickness in the range of ten thousandths of an inch to forty thousandths of an inch in the corrugations.

7. The composite co-extruded tubing assembly according to claim 7, wherein the inner layer has a thickness in the range of ten thousandths of an inch to forty thousandths of an inch in the corrugations.

8. A washing machine composite co-extruded corrugated tubing assembly comprising:
an outer corrugated protective layer having inner and outer corrugated surfaces;
an inner corrugated layer of a soft thermoplastic elastomer alloy material having inner and outer corrugated surfaces,
the inner layer outer corrugated surface being in contact with the protective layer inner corrugated surface over substantially the entire length of each layer through a co-extrusion process, the inner corrugated layer comprising a means for sealing the tubing assembly to the washing machine; and
at least one non-corrugated end seal, the end seal comprising an outer protective layer having inner and outer non-corrugated surfaces; and an inner layer having inner and outer non-corrugated surfaces, the inner layer comprising a means for sealing the tubing assembly to the washing machine, the means for sealing comprising a soft thermoplastic elastomer alloy material,
the end seal protective layer inner non-corrugated surface being in contact with the end seal protective layer outer non-corrugated surface, each end seal layer being monolithic with a corresponding corrugated layer through a co-extrusion process.

9. The composite co-extruded tubing assembly according to claim 9, wherein corrugations of the inner layer outer corrugated surface are in nesting engagement with corrugations of the protective layer inner corrugated surface.

10. A method for forming a household appliance composite co-extruded corrugated tubing assembly comprising:
providing a relatively rigid plastic material;
providing a softer thermoplastic elastomeric alloy material;
co-extruding the relatively rigid plastic material and the softer thermoplastic elastomeric alloy material, the step of co-extruding comprising: extruding an outer corrugated protective layer of the relatively rigid plastic material, the outer protective having inner and outer corrugated surfaces; and, simultaneously extruding an inner corrugated layer of the softer thermoplastic elastomeric material, the inner layer having inner and outer corrugated surfaces, during the step of co-extruding the inner layer outer corrugated surface being formed in contact with the protective layer inner corrugated surface over substantially the entire length of each layer.

11. The method according to claim 11, wherein the step of co-extruding includes forming the corrugations of the inner layer outer corrugated surface in nesting engagement with the corrugations of the protective layer inner corrugated surface.

12. The method according to claim 11, further comprising:
co-extruding the relatively rigid plastic material and the softer thermoplastic elastomeric alloy material forming a non-corrugated end seal, the end seal comprising an outer protective layer of the relatively rigid plastic material having inner and outer non-corrugated surfaces; and an inner layer of the softer thermoplastic elastomeric alloy material having inner and outer non-corrugated surfaces, wherein the softer thermoplastic elastomeric alloy material is adapted to seal the tubing assembly to household appliances, the end seal protective layer being formed in contact with the end seal outer protected layer, each end seal layer being monolithic with a corresponding corrugated layer.
